(19) United States
(12) Patent Application Publication
(10) Pub. No.: US 2008/0034719 A1
(43) Pub. Date: Feb. 14, 2008

(54) Diesel particulate filter having improved thermal durability

(75) Inventors: Hyun-Sik Han, Ansan-city (KR); Jae-Ho Bae, Bucheon-city (KR); Jae-Uk Han, Ansan-city (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Heesung Engelhard Corporation

(21) Appl. No.: 11/811,732

(22) Filed: Jun. 12, 2007

(30) Foreign Application Priority Data
Jun. 20, 2006 (KR) 2006-0055451

(51) Int. Cl. F01N 3/021; B01D 50/00

(52) U.S. Cl. 55/524

(57) ABSTRACT

Disclosed is a diesel particulate filter, including a plurality of cells, which are partitioned by porous cell walls and are closed in a staggered manner by plugs at the upstream end of the filter and at the opposite downstream end thereof, wherein a first oxidation catalyst coating layer is formed on the entire surfaces of the cell walls of the cells that are open at the upstream end of the filter, and a second oxidation catalyst coating layer is formed on the surfaces of the cell walls of the cells, which are open at the downstream end of the filter, in the downstream half part of the filter.

### BACKGROUND OF THE INVENTION

1. Field of the Invention

The present invention relates, generally, to a diesel particulate filter (DPF), and more particularly, to a DPF including a plurality of cells, in which the amount of a catalyst, which is applied in the longitudinal direction of the cells, is controlled to thus physically change the flow of exhaust gas, such that a great amount of particulate is trapped in a predetermined portion of the filter, thereby solving the problems of temperature increase and non-uniform temperature distribution upon the forcible regeneration of the filter, resulting in improved thermal durability.

2. Description of the Related Art

Various materials contained in diesel exhaust gas cause pollution, and accordingly have a somewhat severe influence on the environment at present. In particular, diesel particulate has been reported to cause allergic disorders and to decrease sperm counts. Thus, there is urgently required research into removing diesel particulate. Here, the term “particulate” indicates particulate matter (PM), including carbon-containing particulates, sulfur-containing particulates, such as sulfates, and high-molecular-weight hydrocarbon particulates.

A DPF is a device that may be continuously used in a manner such that diesel PM trapped in the filter is burned and the DPF is regenerated to a state in which it can trap PM again, which enables the removal of 80% or more of soot, thus resulting in superior performance. Recently, CSF (Catalyzed Soot Filter), obtained by coating the DPF with an oxidation catalyst, has been increasingly used. The filter may be formed of metals, alloys, or ceramics. As a typical example of a ceramic filter, a cordierite-based honeycomb filter is known. In recent years, as the material for the filter, particularly useful is a sintered porous silicon carbide body, which is advantageous because it has high heat resistance, mechanical strength and filtration efficiency, is chemically stable, and has low pressure loss. Here, the term “pressure loss” means a value obtained by subtracting the pressure at the downstream end of the filter from the pressure at the upstream end of the filter. Subjecting the exhaust gas to resistance when passing it through the filter is considered to be a main factor causing pressure loss.

The conventional cordierite-based honeycomb filter has a plurality of cells extending along the axial length thereof. When the exhaust gas is passed through the filter, the PM is trapped in the cell walls thereof, thereby removing the PM from the gas component of the exhaust gas. However, the honeycomb filter suffers because pressure loss attributable to the deposition of PM is increased in proportion to the increase in the use time thereof. Thus, in the case of DPF, there is a need to periodically remove the deposited PM. In the case where the pressure loss is increased, the deposited PM is burned using a burner or an electric heater to thus remove it. However, as the amount of the deposited PM increases, the temperature of the filter required for burning the PM is also increased upon forcible regeneration. Consequently, the DPF may break due to thermal stress attributable to the temperature increase.

The architecture of the conventional honeycomb filter is described with reference to FIG. 1, and the problems thereof are pointed out as follows. FIG. 1 is a perspective view and a partially enlarged sectional view illustrating a conventional cylindrical cordierite-based DPF. The honeycomb DPF 10 includes a plurality of cells 12′, 12″, which have approximately square sections, are regularly formed along the axial length thereof, and are partitioned by thin cell walls 13. Approximately half of the plurality of cells are open at the upstream end 9a of the filter, and the remaining half thereof are open at the opposite downstream end 9b thereof. The surfaces or porous surfaces of the inner cell walls 13 of the cells 12′, open at the upstream end 9a of the filter, are impregnated with an oxidation catalyst 30, including a platinum group element or another metal element and oxide thereof. The openings of the cells 12′, 12″ are alternately closed by plugs 15 at the upstream and downstream ends 9a , 9b of the filter. The entire section of the conventional filter structure has a checkered pattern. The density of the cells is set to be about 200/inch², and the thickness of the cell wall 13 is set to be about 0.3 mm. While the exhaust gas, supplied into the cells 12′ open at the upstream end 9a of the filter, is passed through the cell walls, the PM is trapped, and the remaining gas component is discharged to the outside through the cells 12″ open at the downstream end 9b of the filter via the pores of the cell walls. As such, the gas component is subjected to oxidation using the oxidation catalyst applied on the cell walls 13, and is thus converted into a harmless component, which is then discharged to the outside in the direction of the downstream end 9b.

However, the PM that is not passed through the pores of the cell walls is trapped in the surfaces or pores of the inner cell walls 13 of the cells 12′ open at the upstream end of the filter, and the trapped amount thereof gradually increases in the direction of exhaust gas flow. That is, the PM increasingly accumulates from the inlets of the cells 12′ open at the upstream end of the filter toward the plugs 15, which are the final portion in the longitudinal direction of the cells. Therefore, in the case where the pressure loss of the cells is increased, the trapped PM is burned using a burner or an electric heater to thus remove it. However, the greater the amount of the trapped PM, the higher the temperature of the filter required to burn the trapped PM. Consequently, cracks may be created due to the temperature increase and non-uniform temperature distribution, resulting from partial heat generation, undesirably breaking the DPF.

### SUMMARY OF THE INVENTION

Accordingly, the present inventors have discovered that the problem of breakage of the DPF due to the temperature increase and non-uniform temperature distribution, that is, the problem of PM burning temperature increase and partial heat generation, is caused by excessive accumulation of the PM in the longitudinal direction (the direction of exhaust gas flow) of the cells open at the upstream end of the filter, and thus have conducted intensive and extensive study to solve this problem, thereby completing the present invention.

An object of the present invention is to provide an oxidation catalyst filter, the downstream half part of which has a double oxidation catalyst coating layer formed on cells open at the downstream end of the filter.

In order to achieve the above object, the present invention provides a DPF, including a plurality of cells, which are partitioned by porous cell walls and are closed in a staggered manner by plugs at the upstream end of the filter and at the opposite downstream end thereof, wherein a first oxidation catalyst coating layer is formed on the entire surfaces of the cell walls of the cells that are open at the upstream end of the filter, and a second oxidation catalyst coating layer is formed on the surfaces of the cell walls of the cells, which are open at the downstream end of the filter, in the downstream half part of the filter.

### BRIEF DESCRIPTION OF THE DRAWINGS

FIG. 1 is a perspective view and a partially enlarged sectional view illustrating a conventional cordierite-based DPF;

FIG. 2 is a perspective view and a partially enlarged sectional view illustrating a cordierite-based DPF, according to the present invention;

FIGS. 3A to 3C are views illustrating the degree of accumulation of the PM in the FL model of the present invention and in the Uniform and FH models for comparison; and

FIGS. 4A to 4C are views illustrating the temperature change, measured using a T3 sensor mounted to the downstream half part of the FL model of the present invention and of the Uniform and FH models for comparison.

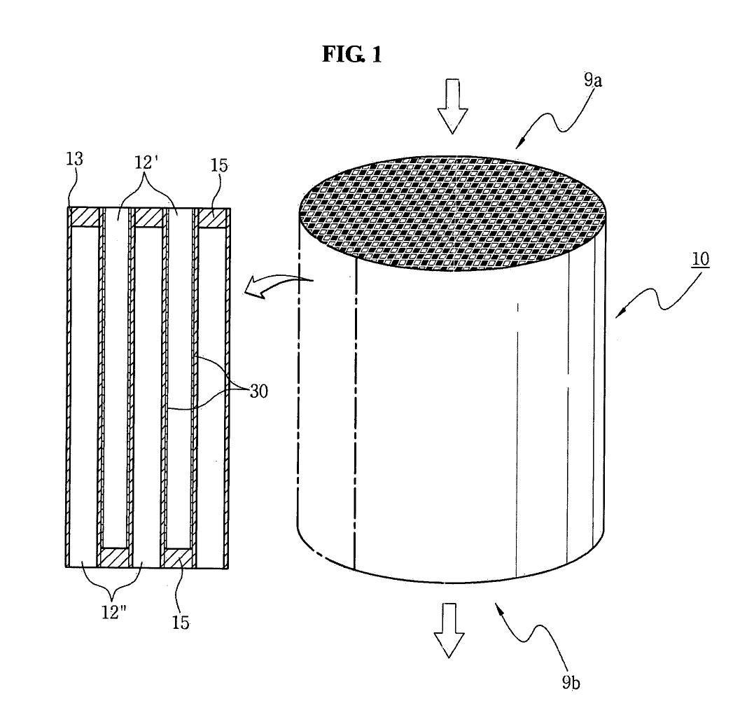

### DESCRIPTION OF THE PREFERRED EMBODIMENTS

According to the present invention, there is provided a DPF including a plurality of cells, in which the flow of exhaust gas is changed, thus simultaneously efficiently passing the gas component of the exhaust gas through the cell walls of the upstream half part 50 (which is the exhaust upstream side) in the longitudinal direction of the cells, and trapping almost all of PM, accompanied by the gas component, in the cell walls of the upstream half part 50. Therefore, the PM may accumulate more in the upstream half part of the filter than in the downstream half part 60 thereof, thereby preventing the temperature of the cell walls of the downstream half part from drastically increasing and solving the problem of non-uniform temperature distribution in the longitudinal direction of the cells, upon the regeneration of the filter through PM combustion. Ultimately, the DPF of the invention may be prevented from cracking due to thermal stress, and hence may have improved thermal durability.

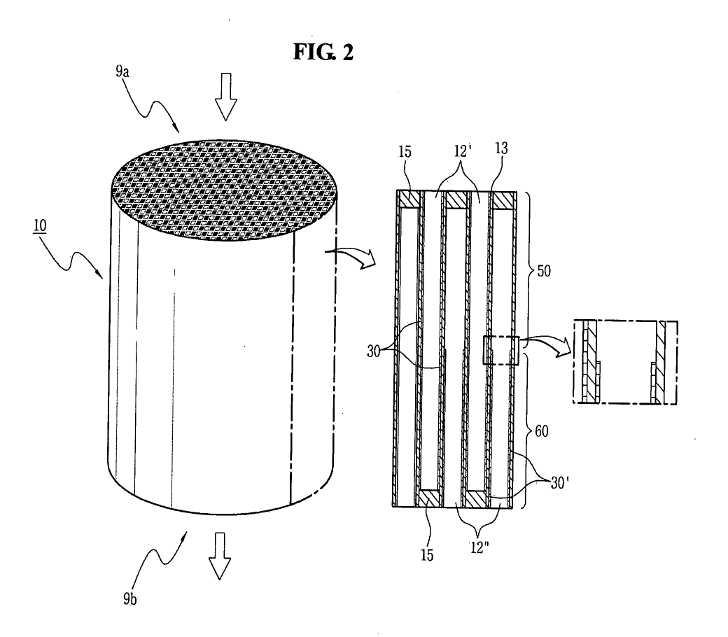

Below, the oxidation catalyst filter according to the embodiment of the present invention is described with reference to the drawings, but the present invention is not limited thereto. In the description of the present invention, the term “section” means a surface perpendicular to the direction of exhaust gas flow, unless otherwise specified. The term “downstream half part” indicates a part where exhaust gas is discharged to the outside through the filter, and the term “upstream half part” indicates a part where exhaust gas is supplied into the filter from an engine. The “upstream half part” and “downstream half part” are not terms that mean that the filter must be divided in a longitudinal direction, but may be understood to mean a portion of the upstream half part and a portion of the downstream half part, respectively, depending on the exhaust gas and engine conditions. FIG. 2 is a schematic perspective view and a partially enlarged sectional view illustrating the oxidation catalyst filter of the present invention.

The DPF of the present invention may be manufactured using heat-resistant ceramics, including cordierite. For example, clay slurry, composed mainly of cordierite powder, is formulated, extruded, and then burned. In place of the cordierite powder, alumina, magnesia, and silica powder may be blended to constitute a cordierite composition. Alternatively, useful is a sintered body selected from among silicon carbide, silicon nitride, sialon, and mullite, having high heat resistance and thermal conductivity. The DPF of the present invention includes a plurality of cells 12′, 12″, which have approximately square sections, are regularly formed along the axial length thereof, and are partitioned by thin cell walls 13. The openings of the cells 12′, 12″ are alternately closed by plugs 15 at the upstream and downstream ends 9a , 9b of the filter. Particularly, approximately half of the plurality of the cells, that is, the cells 12′ are open at the upstream end 9a of the filter, and the remaining cells 12″ are open at the opposite downstream end 9b thereof. In the DPF of the present invention, a first oxidation catalyst coating layer 30 including a platinum group element or another metal element and oxide thereof is formed on the entire surfaces and porous surfaces of the inner cell walls 13 of the cells 12′, which are open at the upstream end of the filter. Further, a second oxidation catalyst coating layer 30′, the composition of which is the same as or different from that of the first oxidation catalyst coating layer 30, is formed on the surfaces and porous surfaces of the inner cell walls of the cells 12″, which are open at the downstream end of the filter, in the downstream half part 60 of the filter. As such, it is noted that no oxidation catalyst coating layer is formed on the surfaces of the inner cell walls of the cells 12″, which are open at the downstream end of the filter, in the upstream half part 50 of the filter. In the structure thus formed, compared to the upstream half part 50 in the longitudinal direction of the cells, the oxidation catalyst coating layers 30, 30′ are formed respectively on both sides of the cell walls of the downstream half part 60, so that the catalyst layer is provided to be relatively thicker in the downstream half part. More specifically, whereas the upstream half part 50 in the longitudinal direction of the cells has the first oxidation catalyst coating layer 30 formed on the inner cell walls of the cells 12′ open at the upstream end of the filter, the downstream half part 60 in the longitudinal direction of the cells has not only the first oxidation catalyst coating layer 30 formed on the inner cell walls of the cells 12′, which are open at the upstream end of the filter, but also the second oxidation catalyst coating layer 30′ formed on the inner cell walls of the cells 12″, which are open at the downstream end thereof. Such a filter structure may cause a change in the direction of exhaust gas flow in the cells of the DPF. The exhaust gas, supplied into the cells 12′ open at the upstream end of the filter, flows in the abutting cells through the pores (porosity 30˜70%) of the cell walls of the upstream half part 50, which has the single catalyst layer and is thus relatively thinner than the downstream half part 60 having the double catalyst layer. Almost all of the PM, accompanied by the gas component of the exhaust gas, is trapped in the cell walls of the upstream half part in the longitudinal direction of the cells, the catalyst layer of the upstream half part being relatively thinner than that of the downstream half part. Over time, the amount of PM accumulated in the upstream half part is greater than the amount of PM accumulated in the downstream half part. Accordingly, in the regeneration of the DPF through the removal of PM, the problems of temperature increase and non-uniform temperature distribution may be solved. That is, because the PM combustion in the upstream half part is greater than the PM combustion in the downstream half part, the temperature of the filter is not drastically increased in the longitudinal direction of the cells, but is expected to gently increase, thereby solving the problem of cracking due to the temperature increase and non-uniform temperature distribution.

In the filter structure of the present invention, known is an oxidation catalyst composition, which is applied on the surfaces and porous surfaces of the inner cell walls of the cells 12′, which are open at the upstream end of the filter, and on the surfaces and porous surfaces of the inner cell walls of the cells 12″, which are open at the downstream end of the filter, in the downstream half part of the filter. For example, the oxidation catalyst coating layer may be formed as follows. That is, oxide powder or composite oxide powder is mixed with a binder, such as alumina sol and water, to thus prepare a slurry. Thereafter, the upstream end of the above filter structure is dipped in the slurry such that the inner cell walls of the cells 12′ open at the upstream end of the filter are coated with the catalyst, followed by conducting drying and burning. In the case where the slurry is incorporated into the cell walls, a typical coating process may be applied. Subsequently, the downstream end of the filter structure is dipped in the slurry, such that only the inner cell walls of the cells 12″, which are open at the downstream end of the filter, in the downstream half part of the filter, are impregnated with the catalyst, after which drying and burning are conducted. The catalyst component incorporated in the catalyst layer includes a catalyst component which is able to reduce NOx through a catalytic reaction and to facilitate the oxidation of PM. Particularly, it is preferred that the catalyst layer be impregnated with one or more selected from the group consisting of platinum group precious metals, including Pt, Rh, and Pd.

Below, the catalyst action and PM trapping of the DPF of the present invention are briefly described. Exhaust gas is supplied to the upstream end 9a of the catalyst filter 10, received in a casing mounted to automobiles, and thus enters the cells 12′ open at the upstream end of the filter. The fluid exhaust gas flows in the abutting cells 12″ through the cell walls 13 of the upstream half part 50, or collides with the plugs 15, which are the final portion in the longitudinal direction of the cells, to thus reach the cell walls of the cells in the downstream half part 60 of the filter. However, because both the first and second oxidation catalyst coating layers 30, 30′ are formed on the cell walls of the downstream half part of the filter, compared to the upstream half part of the filter, it is difficult for the gas component of the exhaust gas to pass through the pores of the cell walls of the downstream half part of the filter. While the direction of flow of the exhaust gas supplied into the cells moves to the upstream half part 50, almost all of the gas component of the exhaust gas is passed through the cell walls of the upstream half part, and thus flows in the abutting cells 12″. Simultaneously, the PM, accompanied by the gas component, is trapped in the predetermined portion where the gas component is passed. Hence, in the upstream half part, the PM is observed to accumulate in a greater amount. While passing through the cell walls 13, HC and CO and/or NOx, contained in the gas, are oxidized, reduced, and purified using the catalyst layers 30, 30′. When the internal temperature of the filter reaches a predetermined temperature, the trapped PM begins to burn due to the action of the precious metal catalyst, such as Pt. Further, when the amount of accumulated PM reaches a predetermined value, the filter is forcibly regenerated. At this time, even though the combustion of the PM of the upstream half part 50 is initiated, the PM does not accumulate to the extent that the PM is continuously burned in the longitudinal direction, and thus the temperature of the filter does not increase to a temperature at which it is possible to crack the DPF. In addition, the temperature distribution, depending on heat generation in the longitudinal direction, becomes gentle, and thus thermal stress is controlled, thereby making it possible to assure the durability of the filter.

In order to evaluate the effects of the structure of the present invention, the structure (FL model) of the present invention, a comparative structure (Uniform model), in which only a first oxidation catalyst coating layer 30 is formed on the entire surfaces of the inner cell walls of the cells 12′, which are open at the upstream end, and another comparative structure (FH model), in which a first oxidation catalyst coating layer 30 is formed on the entire surfaces of the inner cell walls of the cells 12′, which are open at the upstream end, and as well, a second oxidation catalyst coating layer 30′ is formed on the first oxidation catalyst coating layer 30 of the upstream half part at the upstream side, were measured for PM accumulation and temperature of the center of the downstream half part of the DPF.

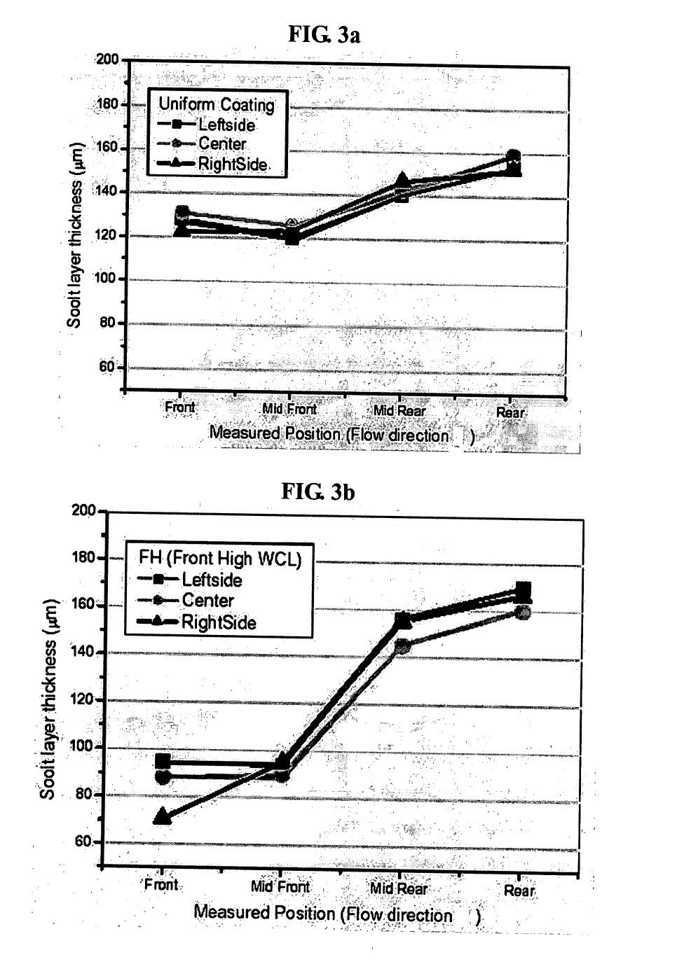

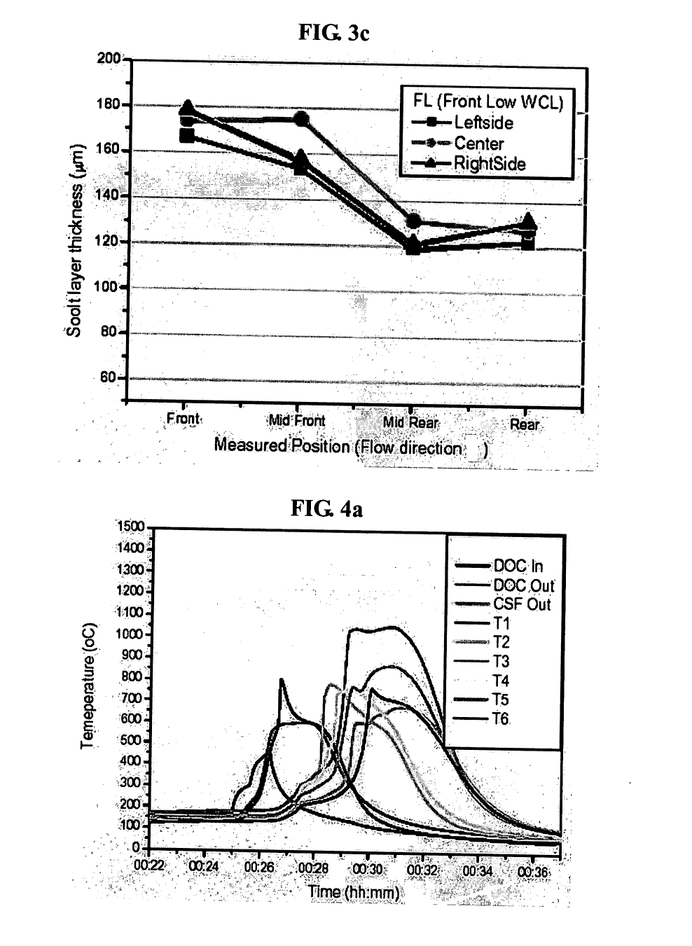

FIGS. 3A to 3C depict the degree of accumulation of PM in the Uniform, FL (inventive), and FH models. In the Uniform and FH models, the PM increasingly accumulates from the upstream half part toward the downstream half part, and the increase slope is drastic in the case of the FH model (FIGS. 3A and 3B). This phenomenon means that almost all of the exhaust gas supplied into the cells is discharged to the outside through the openings of the downstream ends near the plugs. In contrast, in the FL model of the present invention, the accumulation of PM is decreased from the upstream half part toward the downstream half part (FIG. 3C). This is because the catalyst is provided in a relatively greater amount on the cell walls of the cells in the downstream half part of the filter due to the additional formation of the catalyst coating layer 30′. Thereby, it is difficult for the gas component of the exhaust gas to pass through the pores of the cell walls of the downstream half part, and thus it moves toward the upstream half part, after which almost all of the gas component of the exhaust gas is passed through the cell walls of the upstream half part to enter the abutting cells 12″. Simultaneously, the PM, accompanied by the gas component, may be seen to be trapped in the predetermined portion where the gas component is passed.

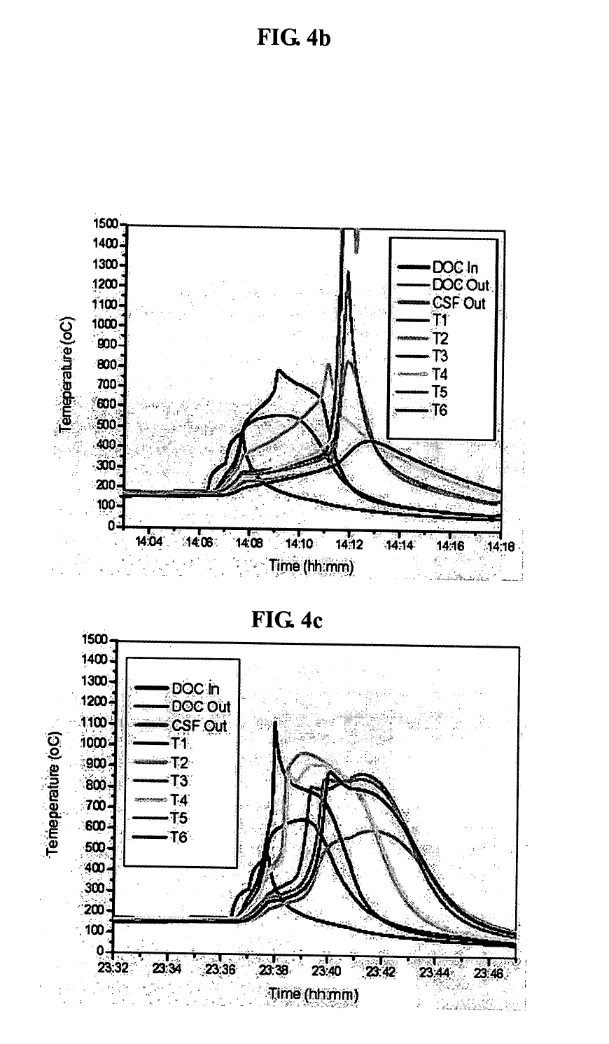

FIGS. 4A to 4C depict the temperature change upon forcible regeneration of the three models. In FIGS. 4A to 4C, T3 indicates a T3 temperature sensor mounted in the DPF, the T3 temperature sensor being mounted to the center of the downstream half part of the DPF. Whereas the Uniform model has T3 of 1050° C. and the FH model has T3 of 1500° C. or higher (FIGS. 4A and 4B), the T3 of the FL model of the present invention is determined to be 850° C. (FIG. 4C). Thus, compared to the Uniform and FH models, the FL model of the present invention can be confirmed to be a structure that is able to control thermal stress, so as to assure durability, because the temperature distribution, depending on heat generation in the longitudinal direction, is gentle.

The results of measurement of the properties of the three models are summarized in Table 1 below.

TABLE 1

| | Peak | Time @ Peak | |
|---|---|---|---|
| Category | Temperature | (mm:ss) | Crack |
| UF | 1050° C. (T3) | 04:20 | No |
| FL | 1100° C. (T1) | 01:40 | No |
| | 850° C. (T3) | | |
| FH | >1500° C. (T3) | 04:40 | Yes |

As described hereinbefore, the DPF structure of the present invention may change the flow of exhaust gas, thus simultaneously efficiently passing the gas component of the exhaust gas through the cell walls of the upstream half part in the longitudinal direction of the cells, and trapping almost all of PM, accompanied by the gas component, in the cell walls of the upstream half part. Therefore, more PM may accumulate in the upstream half part than in the downstream half part, thereby preventing the temperature of the downstream half part from drastically increasing and solving the problem of non-uniform temperature distribution in the longitudinal direction of the cells, upon the regeneration of the filter. Ultimately, the DPF of the invention may be prevented from cracking due to thermal stress, and hence may have improved thermal durability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A diesel particulate filter, comprising a plurality of cells, which are partitioned by porous cell walls and are closed in a staggered manner by plugs at an upstream end of the filter and at an opposite downstream end thereof, wherein a first oxidation catalyst coating layer is formed on entire surfaces of the cell walls of the cells that are open at the upstream end of the filter, and a second oxidation catalyst coating layer is formed on surfaces of the cell walls of the cells, which are open at the downstream end of the filter, in a downstream part of the filter.

2. The diesel particulate filter as set forth in claim 1, wherein each of the first and second oxidation catalyst coating layers comprises one or more selected from a group consisting of platinum group precious metals, including Pt, Rh, and Pd.
